(19) United States
(12) Patent Application Publication
(10) Pub. No.: US 2010/0254618 A1
(43) Pub. Date: Oct. 7, 2010

(54) Method for Accessing Image Data and Related Apparatus

(76) Inventor: Yu-Min Chen, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/566,644

(22) Filed: Sep. 24, 2009

(30) Foreign Application Priority Data
Apr. 1, 2009 (TW) 098110852

(51) Int. Cl. G06K 9/36

(52) U.S. Cl. 382/232

(57) ABSTRACT

A method for accessing image data is disclosed. The image data includes a plurality of pixel data arranged in rows and columns, and every specific amount of pixel data rows forms a pixel group. The method includes writing the image data into an N-line image data register row-by-row successively, and reading the pixel data of each pixel group in a block-row form for image compression.

### BACKGROUND OF THE INVENTION

1. Field of the Invention

The present invention relates to a method and related apparatus for accessing image data, and more particularly, to a method and related apparatus capable of transforming YUV-format image data into block-based image data.

2. Description of the Prior Art

With the rapid progression of multimedia technology, digital imaging techniques are frequently applied in daily life. A user can exchange various image data anytime and anywhere through the Internet or a portable storage apparatus. File sizes of digital images are becoming larger, so image data is often compressed for storage and transmission. For example, Joint Photographic Coding Expert Group (JPEG) compression is often utilized for encoding and decoding, transmission, storage, or display of image data. In general, JPEG is a block-based image compression technology. But, an image sensor usually outputs line-based image data with a raster scan. Therefore, a process is needed for transforming the line-based image data into block-based data to conform to the compression format.

Please refer to FIG. 1(a), which is a schematic diagram of an image compression system 10 in the prior art. The image compression system 10 includes an image capture unit 102, an image processing unit 104, an image access unit 106, and an image compression unit 108. The image capture unit 102 is utilized for capturing raw image data S_{RAW}. The image capture unit 102 is usually implemented by a charge coupled device (CCD) or a complementary metal oxide semiconductor (CMOS) sensor. The image processing unit 104 can transform the image data S_{RAW} into a YUV compression format image data S_{YUV}. After that, the image access unit 106 transforms the line-based YUV-compression formatted image data S_{YUV} into compressible block-based image data S_{block} provided to the image compression unit 108 for implementing a compression process.

Please refer to FIG. 1(b), which illustrates a schematic diagram of an image format transformation in the prior art. As shown in FIG. 1(b), the image processing unit 104 converts 1024×768 pixel image data S_{RAW} into RGB format image data after retrieving RGB component data of each pixel of the image data S_{RAW} through image interpolation and separation processes. The image processing unit 104 then transforms the RGB format image data into YUV-format image data, in which the Y component represents luminance information of the image pixel, and the U and V components represent chrominance information of the image pixel. The image processing unit 104 further transforms the YUV-format image data into YUV422 format image data S_{YUV} through a corresponding sampling process. Therefore, the image access unit 106 transforms the line-based YUV-format image data S_{YUV} into compressible block-based image data S_{block}. Taking the YUV422 format, for example, a Minimum Coded Unit (MCU) can be formed by four 8×8 blocks (Y₁, Y₂, U₁, V₁) arranged in order for a JPEG compression process.

For transforming the line-based YUV-format image data S_{YUV} into compressible block-based image data S_{block}, an A/B buffer structure is disclosed in US publication document No. 2008-024593. Please refer to FIG. 2. FIG. 2 is a schematic diagram of an A/B buffer structure 20 in the prior art. The A/B buffer structure 20 includes an A buffer 202, a B buffer 204, a writing address controller 206, a reading address controller 208, a first switch 210, and a second switch 212. The A buffer 202 and the B buffer 204 are both 16-line buffers. The first switch 210 controls whether to write the YUV-format image data S_{YUV} into the A buffer 202 or the B buffer 204. The second switch 212 controls reading of the block-based image data S_{block} from the A buffer 202 or the B buffer 204. The writing address controller 206 and the reading address controller 208 are utilized for writing or reading the image data in the buffer according to a clock CLK, a horizontal synchronization signal H_{SYNC}, and a vertical synchronization signal V_{SYNC}. Thus, while the YUV-format image data are written into the A buffer 202, the block-based image data are read out from the B buffer 204, and vice versa. However, by using the A/B buffer structure, future image data are further written into the buffer until the image data stored in the 16-line buffer have been read out entirely, consuming more memory devices and waiting time. In addition, an 8-line memory array is disclosed in US publication document NO. 2007-0098272, which establishes a corresponding pointer and uses a look-up table method for managing the order of reading out or writing into the memory array to transform line-based image data into block-based image data. However, although the method only needs half the memory of the A/B buffer structure, the extra storage and inquiry operations of the pointer and extra logic processes also require many memory devices and system processing resources. Thus, a solution is needed for providing a real-time compression process and reducing hardware cost.

### SUMMARY OF THE INVENTION

It is therefore a primary objective of the claimed invention to provide a method and related apparatus for accessing image data.

The present invention discloses method for accessing image data, wherein the image data includes a plurality of pixel data arranged in rows and columns, and every specific amount of pixel data rows forms a pixel group, the method comprising: writing the image data into an N-line image data register row-by-row successively, and reading the pixel data of each pixel group in a block-row form for image compression.

The present invention further discloses an image data access apparatus for transforming image data into compressible image data, wherein the image data includes a plurality of pixel data arranged in rows and columns, and every specific amount of pixel data rows forms a pixel group. The image data access apparatus comprises an N-line image data register for storing the image data; a writing address generator for generating a writing address of the N-line image data register according to the image data; a reading address generator for generating a reading address of the N-line image data register according to each of the pixel group; a first clock generator coupled to the N-line image data register, the writing address generator, and the reading address generator for generating a first writing clock and a first reading clock; and a control unit coupled to the writing address generator, the reading address generator, the first clock generator, and the N-line image data register for controlling the image data to be written into or read out the N-line image data register according to an image initial signal, the first writing clock, the first reading clock, the writing address, and the reading address; wherein the control unit controls the image data to be written into the N-line image data register row-by-row successively according to the image initial signal, the first writing clock, and the writing address, and the control unit controls the pixel data of each pixel group to be read in a block-row form according to the image initial signal, the first reading clock, and the reading address, and transmits the read block-row form pixel data to an image compression unit for image compression.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1(a) is a schematic diagram of an image compression system in the prior art.

FIG. 1(b) is a schematic diagram of an image format transformation in the prior art.

FIG. 2 is a schematic diagram of an A/B buffer structure in the prior art.

FIG. 3 is a schematic diagram of a procedure according to an embodiment of the present invention.

FIG. 4 is a schematic diagram illustrating the operation of writing the image data into a 12-line image data register according to an embodiment of the present invention.

FIG. 5 to FIG. 7 are schematic diagrams illustrating to read the block-based image data according to an embodiment of the present invention.

FIG. 8 is a schematic diagram of configuration for processing YUV 422 and 444 compression format image data with 12-line image data register according to an embodiment of the present invention.

FIG. 9 is a schematic diagram of an image data access apparatus according to another embodiment of the present invention.

FIG. 10 is a schematic diagram of a writing address generator according to another embodiment of the present invention.

FIG. 11 is a schematic diagram of a reading address generator according to another embodiment of the present invention.

FIG. 12 is a schematic diagram of an image data access apparatus according to another embodiment of the present invention.

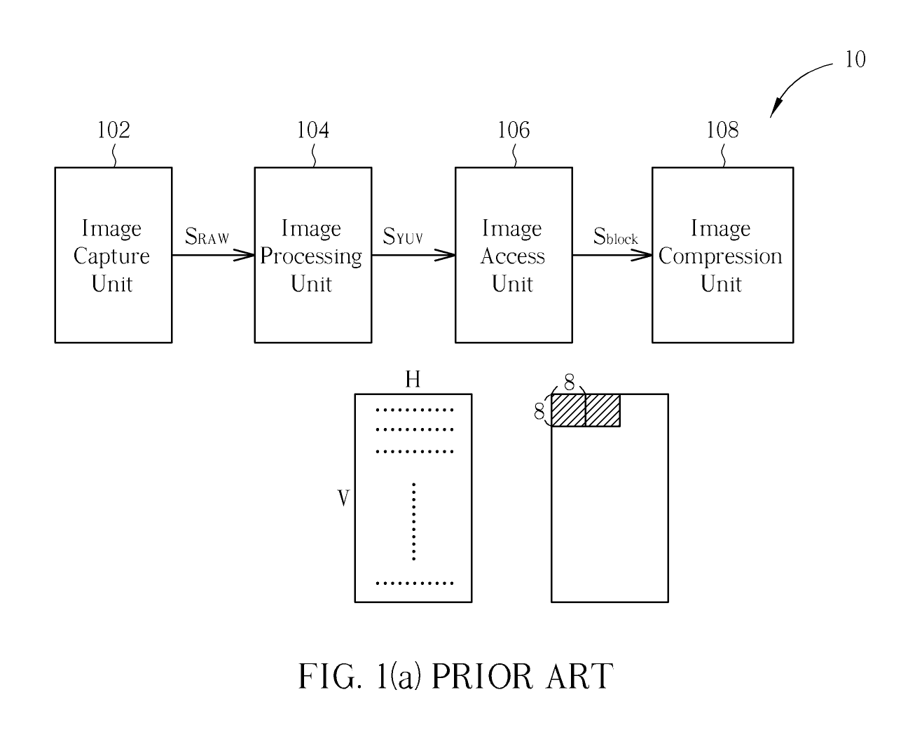

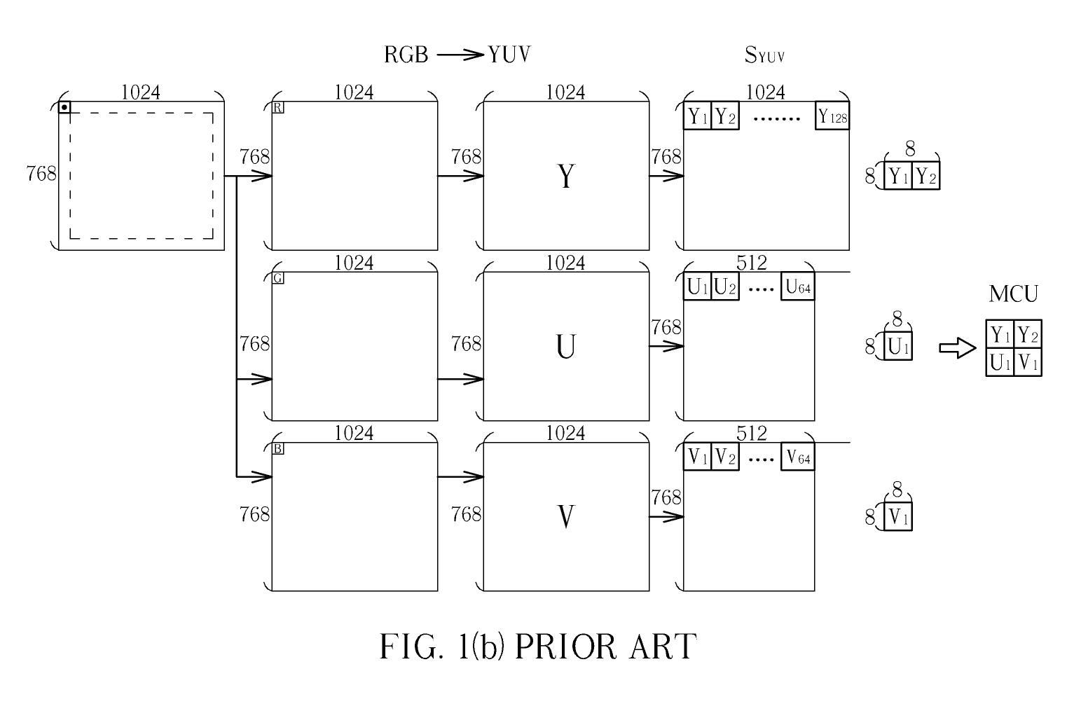

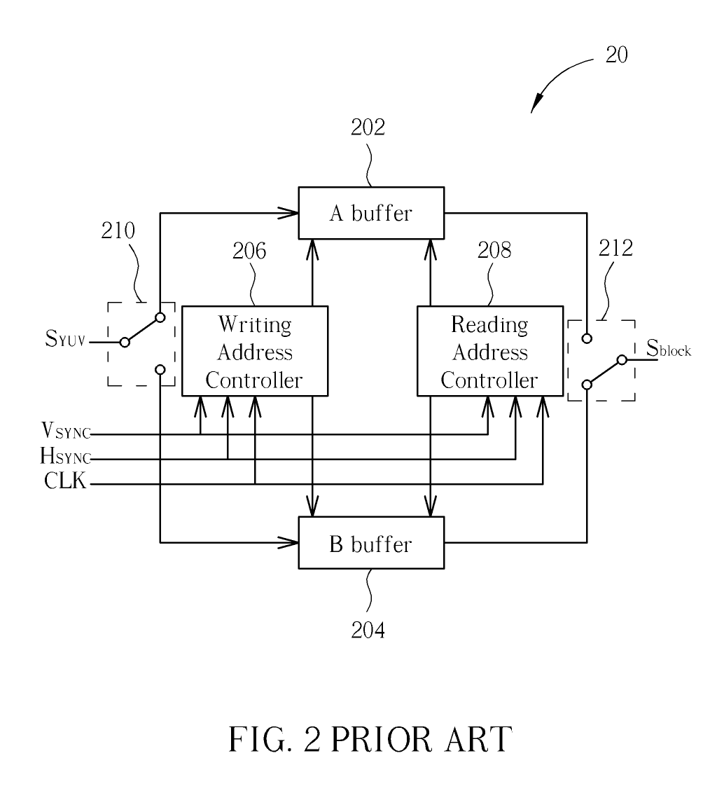

### DETAILED DESCRIPTION

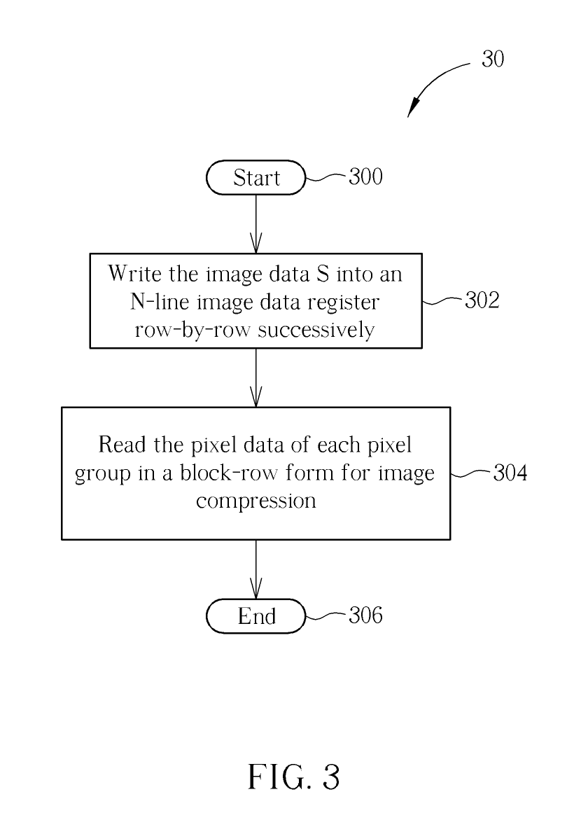

FIG. 3 is a schematic diagram of a procedure 30 according to an embodiment of the present invention. The procedure 30 is utilized for accessing image data S. The image data S includes H×V pixel data arranged in rows and columns, and every specific amount W of pixel data rows forms a pixel group. The procedure 30 comprises the following steps:

Step 300: Start.

Step 302: Write the image data S into an N-line image data register row-by-row successively

Step 304: Read the pixel data of each pixel group in a block-row form for image compression.

Step 306: End.

According to the procedure 30, the present invention writes the image data S into an N-line image data register row-by-row successively, and reads the pixel data of each pixel group in a block-row form from the N-line image data register for image compression after the pixel data of each pixel group begins to be written into the N-line image data register. In brief, compared with the prior art, the present invention can write the image data S into the N-line image data register continuously without waiting for all of the pixel data of the present pixel group to be read out, and the present invention only needs one register to implement block-based transformation immediately, enhancing processing efficiency and reducing manufacturing cost.

On the other hand, the N-line image data register is preferably an H×N register array. The amount N of rows of the N-line image data register can be any number from 9 to 15. In other words, the N-line image data register can be set to any mode from 9-lines to 15-lines. Thus, in contrast to the prior art, the present invention is able to deal with 16/15 to 16/9 times more image data than the prior art for a fixed register size.

In addition, in the step 302, each pixel data row of the image data S can be written into a corresponding row in the N-line image data register pixel by pixel. The row amount of the corresponding row is the value of the row amount of the pixel data row modulo N (mod N). Moreover, in the step 304, the pixel data of each pixel group can be read out in an 8×8 block form along the direction of the row of the N-line image data register successively, and the pixel data of each 8×8 block can be read out row-by-row in order.

Note that, the procedure 30 is an exemplary embodiment of the present invention and those skilled in the art can make alternations and modifications accordingly. For example, the specific amount W is preferably 8, and should not be a limitation of the present invention. The image data S can be Y component image data, U component image data, or V component image data of YUV422 compression format image data or YUV444 compression format image data. The block form image data read from the N-line image data register may be provided for any block-based image compression technique, such as JPEG, Moving Picture Experts Group (MPEG), H.263, or Vector Quantization coder (VQ-coder), etc. Moreover, in the step 304 of the procedure 30, as the image data of a pixel group begins to be written into the N-line image data register, the present invention can start to read the pixel data of the pixel group in the block-row form, based on any pixel data stored in the N-line image data register not being overwritten with the following pixel data. In other words, each pixel data of the pixel group stored in the N-line image data register must be read out ahead, so that the following pixel data may be written to the positions storing the pixel data of the pixel group in the N-line image data register. For example, if the reading speed is higher than the writing speed, and the pixel data are read out from the N-line image data register beginning at a specific moment, this will ensure each pixel data of the pixel group stored in the N-line image data register will not be lost before reading. In an embodiment, the present invention can begin to read the pixel data of each pixel group in a block-row form when the final row of each pixel group is written into the N-line image data register, and read out all of the pixel data of each pixel group within (N−7) row writing time, wherein the row writing time is the required time for the image data to be written into a corresponding row of the N-line image data register successively. As a result, the writing and reading operations will be implemented smoothly by setting a proper writing speed and reading speed.

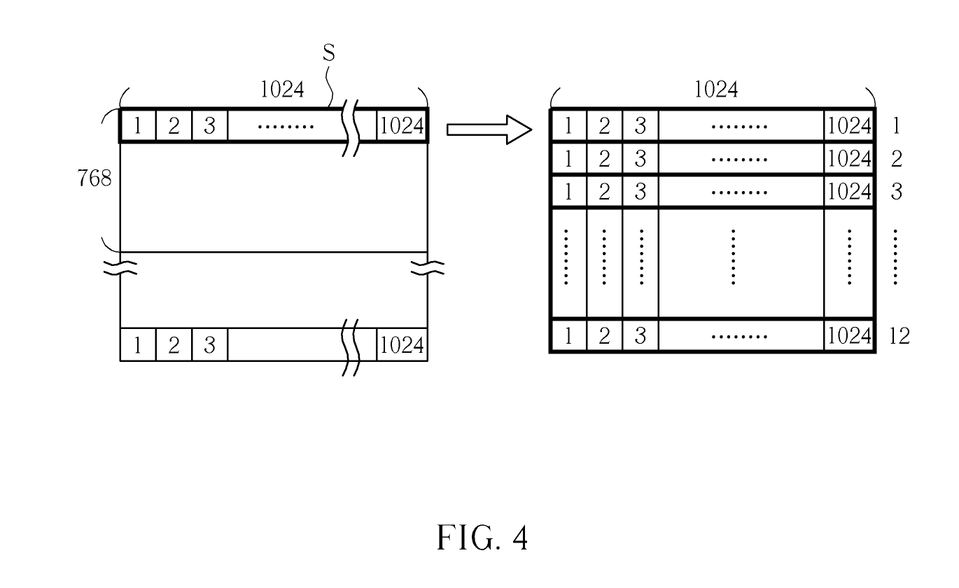

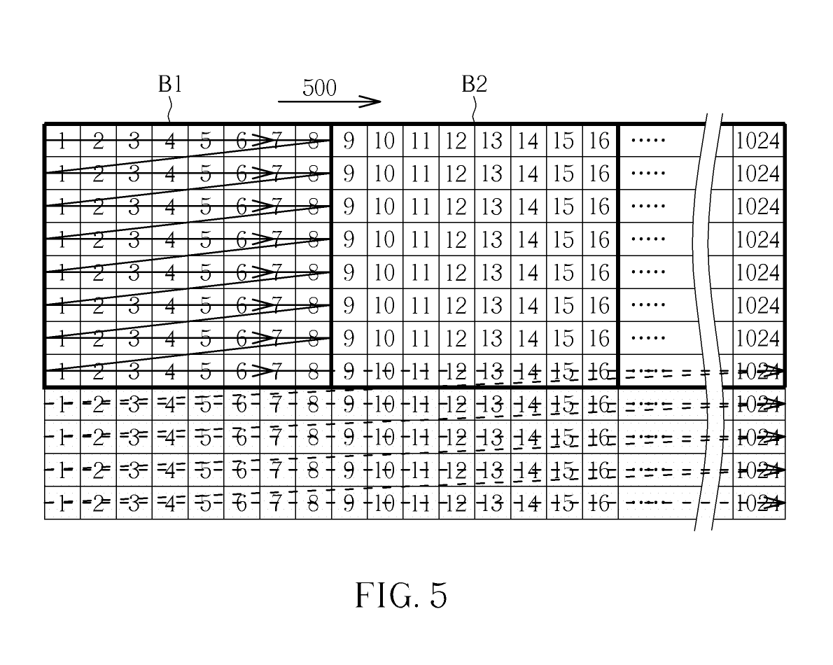

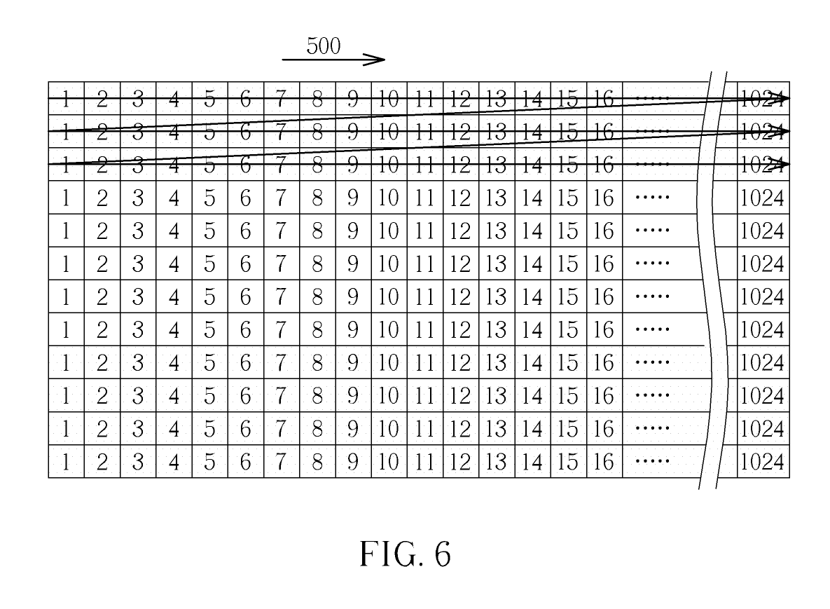

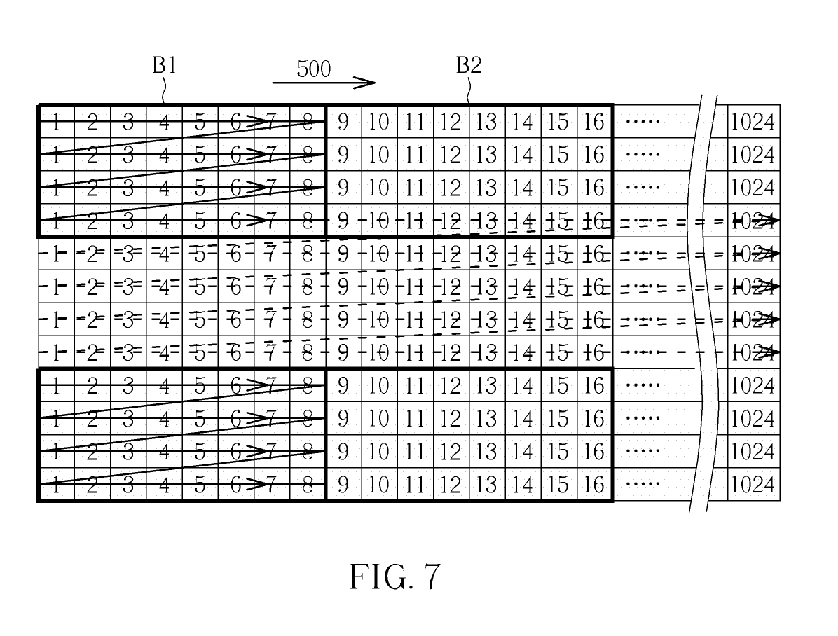

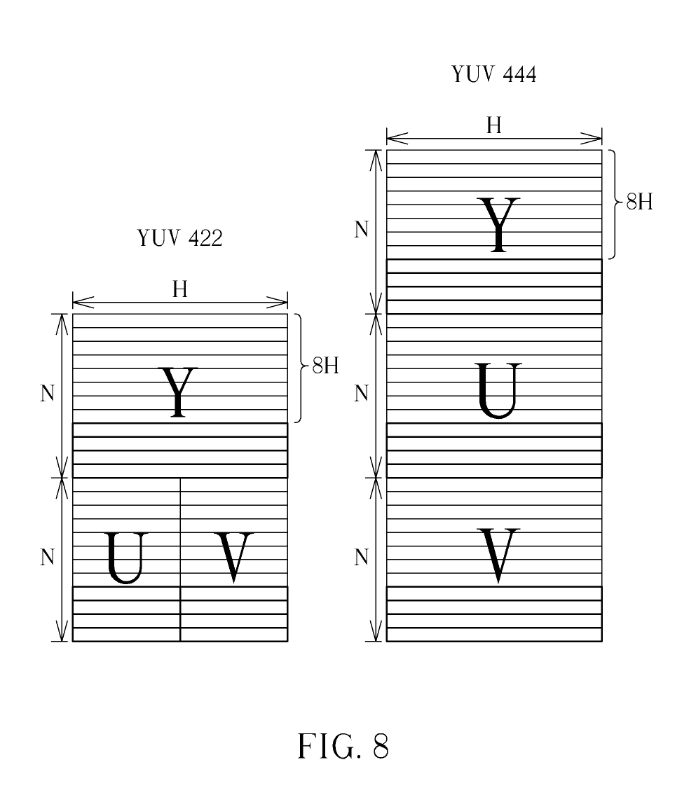

The following further elaborates the operation of the present invention. First, take N=12 for example, i.e. a 12-line image data register is utilized for illustration to transform line-based image data S into block-based image data S_{block}. Suppose the image data S is Y component image data of YUV422 compression format image data, which includes 1024×768 pixel data arranged in rows and columns. Every 8 pixel data rows forms a pixel group. The 12-line image data register is a 1024×12 pixel register array. Please refer to FIG. 4. FIG. 4 is a schematic diagram illustrating the operation of writing the image data S into the 12-line image data register according to an embodiment of the present invention. The image data S are written into the 12-line image data register row-by-row successively. Furthermore, please refer to FIG. 5 to FIG. 7. FIG. 5 to FIG. 7 are schematic diagrams illustrating reading the block-based image data according to an embodiment of the present invention. As shown in FIG. 5, when the final row (the 8th row of the image data S) of the first pixel group (from the 1st row to the 8th row of the image data S) begins to be written into the 12-line image data register, the pixel data of the pixel group stored in the 12-line image data register begin to be successively read out in an 8×8 block form along a first direction 500 immediately, i.e. first from block B₁, then from block B₂. In such a manner, all the pixel data of the first pixel group (pixel data of the image data S from the 1st row to the 8th row) can be read out. The pixel data in each 8×8 block are read out row-by-row from left to right (along the first direction 500) in order. During the reading process, the following image data are still written into the 12-line image data register successively. In such a condition, the pixel data of the first pixel group can be read out completely before the image data S is written to the final row of the 12-line image data register. In other words, each pixel data of the pixel group needs to be read out within 5 (12−7=5) rows writing time for avoiding a data overflow problem, wherein the row writing time is the required time for the image data S to be written into a corresponding row of the 12-line image data register successively, so that the image data S can be written into the final row of the 12-line image data register, and into the first row of the 12-line image data register continuously. As shown in FIG. 6, the front four rows of the second pixel group are written into the rows (from the 9th row to the 12th row) of the 12-line image data register while the first pixel group is being read out, so that pixel data of the second pixel group can begin to be read after 3 (8−(12−7)=3) rows writing time. As shown in FIG. 7, when the final row (the 16th row of the image data S) of the second pixel group (pixel data of the image data S from the 9th row to the 16th row) begins to be written into the 12-line image data register, the pixel data of the second pixel group begin to be successive read out in an 8×8 block form along a first direction 500 immediately, and likewise to deal with U component image data or V component image data of the image data S for transforming the line-based image data S into block-based image data for JPEG image compression. Please refer to FIG. 8. FIG. 8 shows processing of H×V pixel data of YUV422 compression format image data and H×V pixel data of YUV444 compression format image data with a 12-line image data register.

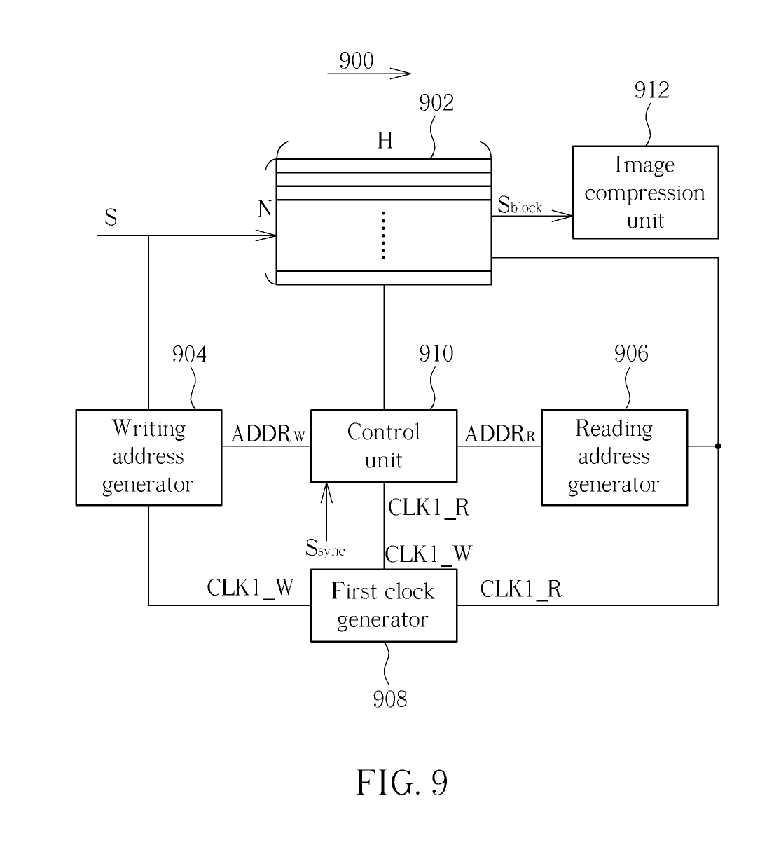

As to implementation of the procedure 30, please refer to FIG. 9. FIG. 9 is a schematic diagram of an image data access apparatus 90 according to another embodiment of the present invention. The image data access apparatus 90 is utilized for transforming image data S into compressible image data S_{block}. The image data S includes a plurality of pixel data arranged in rows and columns, and every specific amount of pixel data rows forms a pixel group. The image data access apparatus 90 includes an N-line image data register 902, a writing address generator 904, a reading address generator 906, a first clock generator 908, and a control unit 910. The N-line image data register 902 is utilized for storing the image data S. The writing address generator 904 is utilized for generating a writing address ADDR_{W} of the N-line image data register 902 according to the image data S. The reading address generator 906 is utilized for generating a reading address ADDR_{R} of the N-line image data register 902 according to each of the pixel groups. The first clock generator 908 is coupled to the N-line image data register 902, the writing address generator 904, and the reading address generator 906 for generating a first writing clock CLK1_W and a first reading clock CLK1_R. The control unit 910 is coupled to the writing address generator 904, the reading address generator 906, the first clock generator 908, and the N-line image data register 902 for controlling the image data S to be written into or read out of the N-line image data register 902 according to an image initial signal S_{sync}, the first writing clock CLK1_W, the first reading clock CLK1_R, the writing address ADDR_{W}, and the reading address ADDR_{R}. The image initial signal S_{sync} indicates the beginning of the image data S. Furthermore, the control unit 910 controls the image data S to be written into the N-line image data register 902 row-by-row successively according to the image initial signal S_{sync}, the first writing clock CLK1_W, and the writing address ADDR_{W}. The control unit 910 can also control the pixel data of each pixel group to be read in a block-row form according to the image initial signal S_{sync}, the first reading clock CLK1_R, and the reading address ADDR_{R}, and transmit the read block-row form pixel data to an image compression unit 912 for image compression. Preferably, the image data S includes H×V pixel data arranged in rows and columns, and the N-line image data register 902 is an H×N two port memory array.

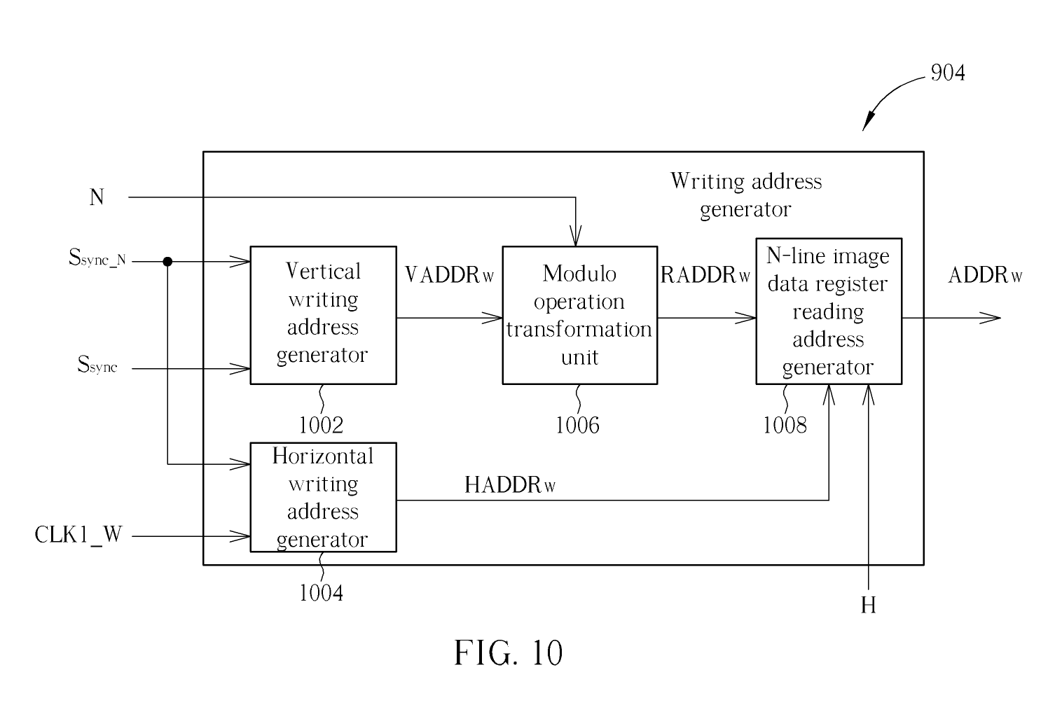

Furthermore, the control unit 910 controls each pixel data row of the image data S to be written into a corresponding row in the N-line image data register 902 row-by-row successively according to the image initial signal S_{sync}, the first writing clock, and the writing address CLK1_W. The row amount of the corresponding row can be obtained through performing a modulo-N operation on the row amount of the pixel data row. On the other hand, the writing address ADDR_{W} is generated by the writing address generator 904. Please refer to FIG. 10. FIG. 10 is a schematic diagram of the writing address generator 904 according to another embodiment of the present invention. The writing address generator 904 includes a vertical writing address generator 1002, a horizontal writing address generator 1004, a modulo operation transformation unit 1006, and an N-line image data register writing address generator 1008. The vertical writing address generator 1002 is utilized for generating a vertical writing address VADDR_{W} according to the image initial signal S_{sync}, a line synchronization signal S_{sync}_{_{—}}_{N}, and the first writing clock CLK1_W. The vertical writing address VADDR_{W} is from 1 to V, the image initial signal S_{sync} indicates the beginning of the image data S, and the line synchronization signal S_{sync}_{_{—}}_{N} indicates the beginning of each pixel data row of the image data S. In this way, the vertical writing address VADDR_{W} can be generated from 1 to V, successively, and re-generated from 1 to V after the image initial signal S_{sync} indicates the next image data S. The modulo operation transformation unit 1006 is utilized for performing a modulo-N operation on the vertical writing address VADDR_{W} to generate a row writing address RADDR_{W} of the N-line image data register 902, i.e. taking the modulo-N value as the row writing address RADDR_{W}. The horizontal writing address generator 1004 is utilized for generating a horizontal writing address HADDR_{W} according to line synchronization signal S_{sync}_{_{—}}_{N} and the first writing clock CLK1_W. The horizontal writing address HADDR_{W} is from 1 to H. In such a condition, the horizontal writing address HADDR_{W} can be generated from 1 to H successively according to first writing clock CLK1_W, and the horizontal writing address HADDR_{W} of the next pixel data row can be generated from 1 to H after the line synchronization signal S_{sync}_{_{—}}_{N} indicates the beginning of the next pixel data row of the image data S. The N-line image data register writing address generator 1008 is utilized for generating the writing address ADDR_{W} according to the horizontal writing address HADDR_{W}, the row writing address RADDR_{W}, and an image width H of the image data S, and transmitting the writing address ADDR_{W} to the control unit 910. Preferably, the writing address ADDR_{W} can be the sum of the product of the row writing address RADDR_{W} and the image width H, and the horizontal writing address HADDR_{W} (i.e. ADDR_{W}=RADDR_{W}×H+HADDR_{W}). Preferably, the vertical writing address VADDR_{W} is generated through incrementation from 1 to V, and each of the following vertical writing addresses VADDR_{W} can be generated after the horizontal writing address HADDR_{W} is generated through incrementation from 1 to H, where H is an image width of the image data, and V is an image height of the image data.

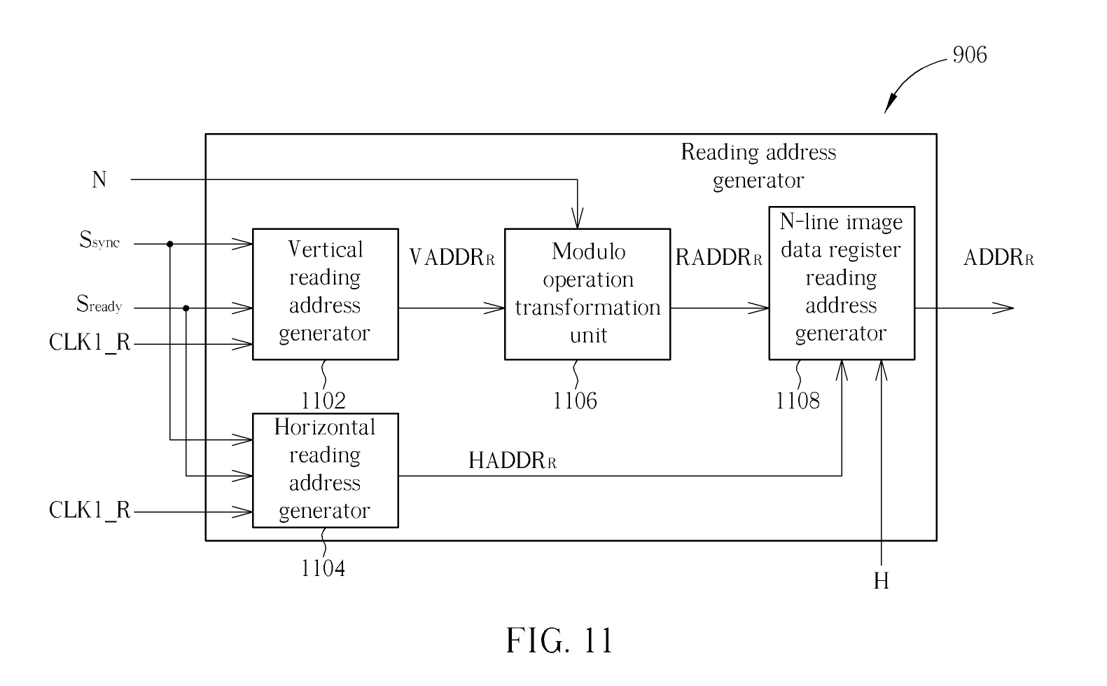

Furthermore, the control unit 910 controls each pixel data row of the image data S the pixel data of each pixel group to be read in an 8×8 block form along the row direction of the N-line image data register 902 successively according to the first reading clock CLK1_R and the reading address ADDR_{R}. Therefore, the control unit 910 transmits a beginning signal S_{ready} to reading address generator 906 after the pixel data of each pixel group begins to be written into the N-line image data register 902. Please refer to FIG. 11. FIG. 11 is a schematic diagram of the reading address generator 906 according to another embodiment of the present invention. The reading address ADDR_{R} is generated by the reading address generator 906. The reading address generator 906 includes a vertical reading address generator 1102, a horizontal reading address generator 1104, a modulo operation transformation unit 1106, and an N-line image data register reading address generator 1108. The vertical reading address generator 1102 is utilized for generating a vertical reading address VADDR_{R} according to the first reading clock CLK1_R, beginning signal S_{ready}, and the image initial signal S_{sync}, in which the vertical reading address VADDR_{R} is from 1 to V, beginning signal S_{ready} indicates readiness to begin generating the reading address, and the image initial signal S_{sync} indicates the beginning of the image data S. The modulo operation transformation unit 1006 is utilized for performing a modulo-N operation on the vertical reading address VADDR_{R} to generating a row reading address RADDR_{R} of the N-line image data register 902, i.e. taking the modulo-N value as row reading address RADDR_{R}. The horizontal reading address generator 1104 is utilized for generating a horizontal reading address HADDR_{R} according to the first reading clock CLK1_R, beginning signal S_{ready}, and the image initial signal S_{sync}, in which the horizontal reading address HADDR_{R} is from 1 to H. The N-line image data register reading address generator 1108 is utilized for generating the reading address ADDR_{R} according to the horizontal reading address HADDR_{R}, and the row writing address RADDR_{R}, S, and transmitting the writing address ADDR_{R} to the control unit 910. The reading address ADDR_{R} can be the sum of the product of the row reading address RADDR_{R} and the image width H, and the horizontal reading address HADDR_{R} (i.e. ADDR_{R}=RADDR×H+HADDR_{R}). Preferably, the reading address ADDR_{R} is generated in an 8×8 block form along the row direction of the N-line image data register 902 according to image initial signal S_{sync} after receiving the beginning signal S_{ready} for reading out each pixel of the pixel group. The reading address ADDR_{R} is generated row-by-row successively along the direction perpendicular to the row direction, and the reading address ADDR_{R} of each row is generated progressively along the first direction in each 8×8 block. Again, the reading address ADDR_{R} of the next pixel is generated after the beginning signal S_{ready} indicates to read the next pixel.

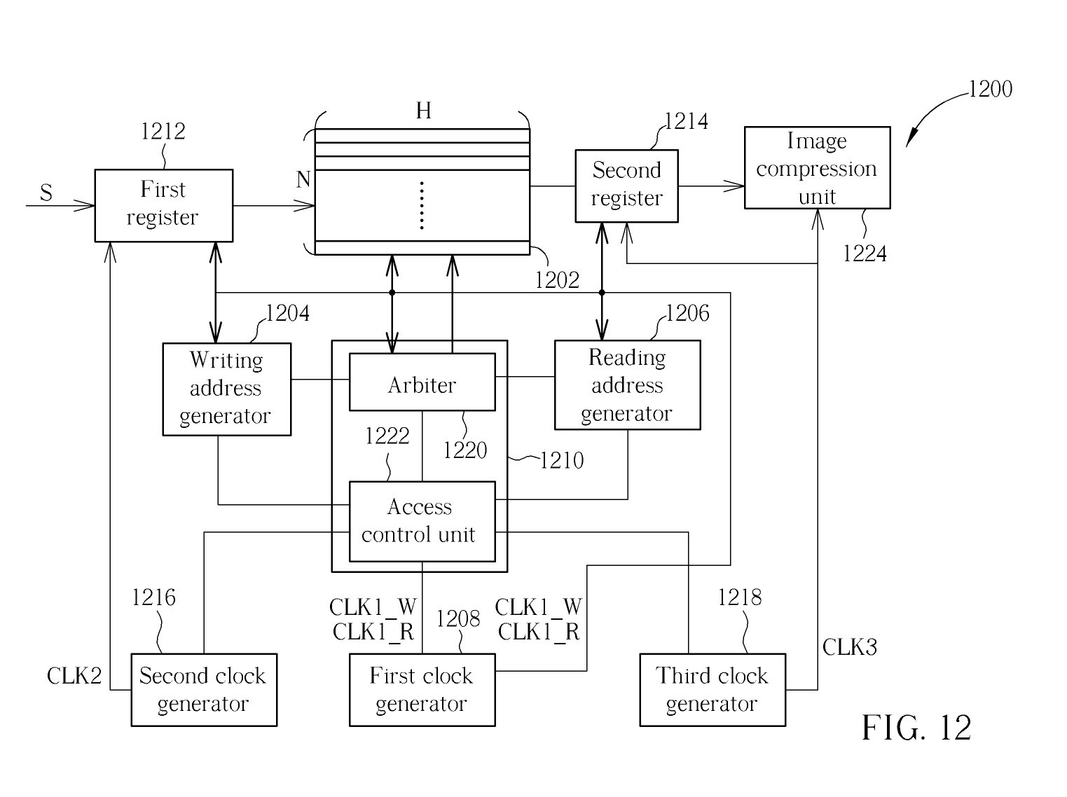

In addition, as the N-line image data register 902 is implemented by an H×N single port memory array, please refer to FIG. 12. FIG. 12 is a schematic diagram of an image data access apparatus 1200 according to another embodiment of the present invention. Please note that the units in the image data access apparatus 1200 shown in FIG. 12 with the same designations as those in the image data access apparatus 90 shown in FIG. 9 have similar operations and functions, and further description thereof is omitted for brevity. The interconnections of the units are as shown in FIG. 12. The image data access apparatus 1200 includes an N-line image data register 1202, a writing address generator 1204, a reading address generator 1206, a first clock generator 1208, and a control unit 1210, a first register 1212, a second register 1214, a second clock generator 1216, and a third clock generator 1218. The control unit 1210 includes an arbiter 1220 and an access control unit 1222. The arbiter 1220 is coupled to the writing address generator 1204, the reading address generator 1206, the first clock generator 1208, and the N-line image data register 1202 for switching a write state or a read state for address bus of the N-line image data register 1202, so as to control the N-line image data register 1202 to access the image data S according to writing address ADDR_{W}, reading address ADDR_{R}, first writing clock CLK1_W, and first reading clock CLK1_R. The access control unit 1222 is coupled to arbiter 1220, writing address generator 1204, reading address generator 1206, the first clock generator 1208, the second clock generator 1216, and the third clock generator 1218 for controlling the arbiter 1220 to switch state of address bus of the N-line image data register 1202 according to an image initial signal S_{sync} and controlling the frequency of the first clock generator 1208, the second clock generator 1216, and the third clock generator 1218. Moreover, the access control unit 1222 can be utilized for notifying the arbiter 1220 of switching the address bus of the N-line image data register 1202 to the write state so that the image data S are written into the N-line image data register 1202 row-by-row successively. Besides, the access control unit 1202 can be utilized for notifying the arbiter 1220 of switching the address bus of the N-line image data register 1202 to the read state so that the pixel data of each pixel group stored in the N-line image data register 1202 are read in a block-row form according to the image initial signal S_{sync}. Finally, the read block-based pixel data are transmitted into the image compression unit 1224 for compression. The first register 1212 is coupled to the N-line image data register 1202 for registering the image data S. The second register 1214 is coupled to the N-line image data register 1202 and the image compression unit 1224 for registering the image data S_{block} read from the N-line image data register 1202. The second clock generator 1216 is coupled to the first register 1212 and the access control unit 1222 for generating a second clock CLK2. The third clock generator 1218 is coupled to the second register 1214 and the access control unit 1222 for generating a third clock CLK3.

In general, a single port memory array allows either a read or a write operation for each cycle time. Therefore, compared with the image data access apparatus 90, the image data access apparatus 1200 further includes a first register 1212, a second register 1214, a second clock generator 1216, and a third clock generator 1218. As the arbiter 1220 switches the address bus of the N-line image data register 1202 to the read state, the first register 1212 registers the pixel data read from the image data S according to second clock CLK2. As the arbiter 1220 switches address bus of the N-line image data register 1202 to the write state, the read image data S_{block} stored in the second register 1214 are read out to the image compression unit 1224. In other words, the first register 1212 performs the reading operation according to the first clock CLK1, and the writing operation according to the second clock CLK2. The second register 1214 performs the reading operation according to the third clock CLK3, and the writing operation according to the first clock CLK1. As to implementation of the procedure 30, the access control unit 1222 controls frequency variation of the first register 1212, the second register 1214, the second clock generator 1216, and the third clock generator 1218 for adjusting processing speed. For example, frequency of the third clock CLK3 can be increased for accelerating read out of the block-based data stored in the second register 1214 to avoid the overflow problem. Similarly, frequency of the second clock CLK2 can be decreased for decelerating writing of data to the first register 1212 for avoiding the above-mentioned overflow problem. Preferably, bandwidth of the N-line image data register 1202 can be double that of the image data, and the bus width of the second register 1214 is the same as that of the N-line image data register 1202.

Note that, the image data access apparatus 90 and the image data access apparatus 1200 are exemplary embodiments of the present invention, and those skilled in the art can make alternations and modifications accordingly. For example, the control unit 910 can transmit a beginning signal S_{ready} to the reading address generator 906 for beginning to generate the reading address ADDR_{R}. The control unit 910 controls the first clock generator 908 to generate the first writing clock CLK1_W and the first reading clock CLK1_R for completely reading the pixel data of each pixel group before pixel data of each pixel group is overwritten with other pixel data. In other words, the control unit 910 transmits a beginning signal S_{ready} to the reading address generator 906 after the pixel data of each pixel group begins to be written into the N-line image data register 902, and controls generation of the proper first writing clock CLK1_W and the first reading clock CLK1_R for ensuring any pixel data of the pixel group stored in the N-line image data register 902 can be read out completely before being overwritten with the following pixel data of another pixel group. For example, the pixel data of each pixel group can begin to be read out in the block-row form when the final row of each pixel group is written into the N-line image data register 902. All of the pixel data of each pixel group can be read out within (N−7) row writing time, and this is not a limitation of the present invention. Preferably, the image data S includes H×V pixel data arranged in rows and columns, the specific amount W is 8, and the amount N of rows of the N-line image data register 902, 1202 is any number from 9 to 15. The image data S can be Y component image data, U component image data, or V component image data in YUV422 compression format image data or YUV444 compression format image data.

In summary, the present invention can write the image data S into the N-line image data register continuously without waiting for all of the pixel data of the present pixel group to be read out, and the present invention needs only one register to implement block-based transformation immediately, enhancing process efficiency and reducing manufacturing cost. Moreover, compared with the prior art, the present invention is able to deal with 16/15 to 16/9 times the image data of the prior art under a fixed register by flexibly choosing image data register mode from 9-lines to 15-lines.

Those skilled in the art will readily observe that numerous modifications and alterations of the device and method may be made while retaining the teachings of the invention.

What is claimed is:

1. A method for accessing image data, wherein the image data includes a plurality of pixel data arranged in rows and columns, and every specific amount of pixel data rows forms a pixel group, the method comprising:
writing the image data into an N-line image data register row-by-row successively, and reading the pixel data of each pixel group in a block-row form for image compression.

2. The method of claim 1, wherein the specific amount is 8.

3. The method of claim 1, wherein the image data comprise H-by-V pixel data arranged in rows and columns.

4. The method of claim 3, wherein the N-line image data register is an H-by-N memory array.

5. The method of claim 1, wherein the amount N of rows of the N-line image data register is any number from 9 to 15.

6. The method of claim 1, wherein the step of writing the image data into the N-line image data register row-by-row successively is writing each pixel data row of the image data into a corresponding row in the N-line image data register row-by-row successively, wherein the row amount of the corresponding row is a value of the row amount of the pixel data row modulo N.

7. The method of claim 1, wherein the step of reading the pixel data of each pixel group in the block-row form for image compression is reading the pixel data of each pixel group in an 8×8 block form along a first direction successively.

8. The method of claim 7, further comprising reading the pixel data of each 8×8 block row-by-row successively.

9. The method of claim 1, wherein the step of reading the pixel data of each pixel group in the block-row form for image compression comprises:
beginning to read the pixel data of each pixel group in the block-row form after the image data of each pixel group begins to be written into the N-line image data register.

10. The method of claim 9, wherein the step of reading the pixel data of each pixel group in the block-row form for image compression comprises:
beginning to read the pixel data of each pixel group in the block-row form when the final row of each pixel group is being written into the N-line image data register.

11. The method of claim 1, wherein the step of reading the pixel data of each pixel group in the block-row form for image compression comprises:
reading the pixel data of each pixel group in the block-row form before pixel data of each pixel group is overwritten with other pixel data.

12. The method of claim 1, wherein the image data are Y component image data, U component image data, or V component image data in YUV422 compression format.

13. The method of claim 1, wherein the image data are Y component image data, U component image data, or V component image data in YUV444 compression format.

14. The method of claim 1, wherein the pixel data read in the block-row form is provided for JPEG image compression.

15. An image data access apparatus for transforming image data into compressible image data, wherein the image data includes a plurality of pixel data arranged in rows and columns, and every specific amount of pixel data rows forms a pixel group, the image data access apparatus comprising:
an N-line image data register for storing the image data;
a writing address generator for generating a writing address of the N-line image data register according to the image data;
a reading address generator for generating a reading address of the N-line image data register according to each of the pixel groups;
a first clock generator coupled to the N-line image data register, the writing address generator, and the reading address generator for generating a first writing clock and a first reading clock; and
a control unit coupled to the writing address generator, the reading address generator, the first clock generator, and the N-line image data register for controlling the image data to be written into or read out of the N-line image data register according to an image initial signal, the first writing clock, the first reading clock, the writing address, and the reading address;
wherein the control unit controls the image data to be written into the N-line image data register row-by-row successively according to the image initial signal, the first writing clock, and the writing address, and the control unit controls the pixel data of each pixel group to be read in a block-row form according to the image initial signal, the first reading clock, and the reading address, and transmits the read block-row form pixel data to an image compression unit for image compression.

16. The image data access apparatus of claim 15, wherein the specific amount of rows is 8.

17. The image data access apparatus of claim 15, wherein the image data comprise H-by-V pixel data arranged in rows and columns.

18. The image data access apparatus of claim 15, wherein the N-line image data register is an H-by-N memory array.

19. The image data access apparatus of claim 18, wherein the amount N of rows of the N-line image data register is any number from nine to fifteen.

20. The image data access apparatus of claim 18, wherein the memory array is a two-port memory array.

21. The image data access apparatus of claim 18, wherein the memory array is a single-port memory array.

22. The image data access apparatus of claim 21, further comprising:
a first register coupled to the N-line image data register for registering the image data;
a second register coupled to the N-line image data register and the image compression unit for registering the image data read from the N-line image data register;
a second clock generator coupled to the first register for generating a second clock; and
a third clock generator coupled to the second register for generating a third clock.

23. The image data access apparatus of claim 22, wherein the control unit comprises:
an arbiter coupled to the writing address generator, the reading address generator, the first clock generator, and the N-line image data register for switching a write state or a read state of an address bus of the N-line image data register to control the N-line image data register to access the image data according to the writing address, the reading address, the first writing clock, and the first reading clock; and
an access control unit coupled to the arbiter, the writing address generator, the reading address generator, the first clock generator, the second clock generator, and the third clock generator for controlling the arbiter to allocate state of the address bus of the N-line image data register according to an image initial signal, and controlling frequency of the first clock generator, the second clock generator, and the third clock generator;
wherein the access control unit notifies the arbiter of allocating writing state for the address bus of the N-line image data register according to the image initial signal so that the image data are written into the N-line image data register row-by-row successively, and the access control unit notifies the arbiter of allocating reading state for the address bus of the N-line image data register so that the pixel data of each pixel group are read in a block-row form according to the image initial signal.

24. The image data access apparatus of claim 23, wherein the first register registers the image data according to the second clock when the arbiter switches the address bus of the N-line image data register to the read state.

25. The image data access apparatus of claim 23, wherein the second register transmits the read image data to the image compression unit according to the third clock when the arbiter switches the address bus of the N-line image data register to the write state.

26. The image data access apparatus of claim 23, wherein the access control unit notifies the arbiter of switching the address bus of the N-line image data register to the read state for reading the pixel data of a pixel group in a block-row form within a specific time when the final row of the pixel group is written into the N-line image data register.

27. The image data access apparatus of claim 26, wherein the pixel data of the pixel group are read in an 8×8 block form along a first direction successively, and the specific time is (N−7) row writing time, wherein the row writing time is the required time for the image data to be written into a corresponding row in the N-line image data register successively.

28. The image data access apparatus of claim 15, wherein the control unit controls each pixel data row of the image data to be written into a corresponding row in the N-line image data register row-by-row successively according to the image initial signal, the first writing clock, and the writing address, wherein the row amount of the corresponding row is a value of the row amount of the pixel data row modulo N.

29. The image data access apparatus of claim 28, wherein the writing address generator comprises:
a horizontal writing address generator for generating a horizontal writing address according to a line synchronization signal and the first writing clock;
a vertical writing address generator for generating a vertical writing address according to the image initial signal, the line synchronization signal, and the first writing clock;
a modulo operation transformation unit for performing a modulo-N operation on the vertical writing address to generate a row writing address of the N-line image data register; and
an N-line image data register writing address generator for generating the writing address according to the horizontal writing address, the row writing address, and an image width of the image data, and transmitting the writing address to the control unit.

30. The image data access apparatus of claim 29, wherein the vertical writing address is generated with progressive increases from 1 to V, and each of the following vertical writing addresses is generated after the horizontal writing address is generated with progressive increases from 1 to H, where H is an image width of the image data, and V is an image height of the image data.

31. The image data access apparatus of claim 15, wherein the control unit controls the pixel data of each pixel group to be read in an 8×8 block form along a first direction successively according to the first reading clock and the reading address.

32. The image data access apparatus of claim 31, wherein the reading address generator comprises:
a horizontal reading address generator for generating a horizontal reading address according to a beginning signal, the image initial signal, and the first reading clock;
a vertical reading address generator for generating a vertical reading address according to the beginning signal, the image initial signal and the first reading clock;
a modulo operation transformation unit for performing a modulo-N operation on the vertical reading address to generate a row reading address of the N-line image data register; and
an N-line image data register reading address generator for generating the reading address according to the horizontal reading address, the row reading address, and an image width of the image data, and transmitting the writing address to the control unit.

33. The image data access apparatus of claim 32, wherein the reading address is generated in an 8×8 block form along a first direction successively.

34. The image data access apparatus of claim 33, wherein the reading address is generated row-by-row successively along a perpendicular direction to the first direction and the reading address of each row is generated progressively along the first direction in each 8×8 block.

35. The image data access apparatus of claim 15, wherein the control unit transmits a beginning signal to the reading address generator after the pixel data of each pixel group begins to be written into the N-line image data register.

36. The image data access apparatus of claim 35, wherein the control unit transmits a beginning signal to the reading address generator when the final row of each pixel group is written into the N-line image data register.

37. The image data access apparatus of claim 15, wherein the control unit controls the first clock generator to generate the first writing clock and the first reading clock for completely reading the pixel data of each pixel group before pixel data of each pixel group is overwritten with other pixel data.

38. The image data access apparatus of claim 15, wherein the image data are Y component image data, U component image data, or V component image data in YUV422 compression format.

39. The image data access apparatus of claim 15, wherein the image data are Y component image data, U component image data, or V component image data in YUV444 compression format.

40. The image data access apparatus of claim 15, wherein the pixel data read in the block-row form is provided for JPEG image compression.
